(19) United States
(12) Patent Application Publication
(10) Pub. No.: US 2025/0214136 A1
(43) Pub. Date: Jul. 3, 2025

(54) SEGMENT OF A SOFT REDUCTION DEVICE FOR CARRYING OUT A SOFT REDUCTION OF SLABS

(71) Applicant: DANIELI & C. OFFICINE MECCANICHE S.P.A., Buttrio (IT)

(72) Inventors: Yoon Jae Lee, Pohang-si, Gyeongsangbuk-do (KR); Massimiliano Covassi, Pavia Di Udine (IT); Riccardo Conte, Ronchi dei Legionari (IT)

(21) Appl. No.: 18/853,705

(22) PCT Filed: Apr. 3, 2023
(86) PCT No.: PCT/IB2023/053333

§ 371 Date: Oct. 2, 2024

(30) Foreign Application Priority Data
Apr. 4, 2022 (IT) 102022000006581

(51) Int. Cl. B22D 11/12; F15B 15/14

(52) U.S. Cl. CPC B22D 11/1206; F15B 15/1423

(57) ABSTRACT

A soft reduction segment of a continuous casting machine, said segment being suitable for carrying out a soft reduction of a slab exiting from said continuous casting machine, the segment comprising

an upper support for supporting upper rollers;

a lower support for supporting lower rollers;

adjustment units having pairs of actuators arranged to adjust a relative inclination between the upper support and the lower support and, thus, between the upper rollers and the lower rollers;

wherein the upper support is divided into a first part, which is proximal to the slab run-in end, and a second part, which is proximal to the slab run-out end, said first part and said second part being connected to each other by at least one first hinge.

### CROSS-REFERENCE TO RELATED APPLICATIONS

This application claims priority to PCT International Application No. PCT/IB2023/053333 filed on Apr. 3, 2023, which applications claims priority to Italian Patent Application No. 102022000006581 filed on Apr. 4, 2022, the entire disclosures of which are expressly incorporated herein by reference.

### STATEMENT RE: FEDERALLY SPONSORED RESEARCH/DEVELOPMENT

Not Applicable

### BACKGROUND

### Field of the Invention

The present invention relates to a segment of a soft reduction device for carrying out a soft reduction of a slab, to the aforesaid soft reduction device and to a related method.

### Background Art

Market demand for slabs with increasingly improved central quality has led to the development and adoption of techniques for reducing the thickness of the slab in line, commonly indicated as soft reduction, the main aims of which are the reduction of segregation and central porosity, which is carried out by crushing the product in proximity to the liquid cone closing area.

The process simulation models have evolved considerably in recent years, ensuring a better estimate of the final solidification point and enabling the development of evolved control strategies such as dynamic soft reduction. However, the efficiency of the current technique is intrinsically limited by the design of the continuous casting machine for slabs, because of the discretization due to the use of soft reduction segments.

The diagram of a first solution of the background art relating to a soft reduction segment is illustrated in FIG. 1. This soft reduction segment is a segment of a continuous casting machine which comprises:
an upper support for supporting upper containment rollers;
a lower support for supporting lower containment rollers;
two adjustment units arranged at the ends of the upper support, each adjustment unit having a pair of adjustment actuators, arranged on the upper support, to adjust a relative inclination between the upper support and the lower support and, thus, between the upper rollers and the lower rollers;
a further pair of actuators, arranged in an intermediate position between the two aforesaid pairs of actuators, to control a motorized roller inside the segment.

As the adjustment units are shown in a side view in FIG. 1, each adjustment unit illustrated in the figure corresponds to a pair of actuators.

Both the upper support and the lower support are made in a respective single piece.

The piston rods of the first pair of adjustment actuators, proximal to the run-in end of the segment, are connected by a respective first hinge, or internal hinge, to a respective further rod constrained to the lower support by a respective second hinge, while the piston rods of the second pair of adjustment actuators, proximal to the run-out end, are constrained to the lower support directly by a respective third hinge.

Currently, common practice provides for slightly calibrating the casting speed to enable the liquid cone or solidification cone to be closed exactly at the last roller of the segment which closes the soft reduction, limiting the flexibility of use of the machine. FIG. 2 schematically illustrates a soft reduction device with a series of segments according to said first solution. The arrow indicates the closing position of the liquid cone.

To control the slab thickness profile with extreme precision, a second known solution provides a system that enables each roller of a segment to be controlled in position, making use of a considerable number of hydraulic actuators, e.g., fourteen. This system on one hand boasts an improvement of the internal quality of the product and greater flexibility of the machine, but on the other hand implies substantial plant engineering complexity.

A need is thus perceived to provide an innovative segment of a soft reduction device, for carrying out a soft reduction of a slab, able to overcome the aforesaid drawback.

### SUMMARY OF THE INVENTION

It is an object of the present invention to provide a segment of a soft reduction device which allows the soft reduction profile to be optimized more flexibly and precisely, and thus more efficiently, without incurring excessive plant complications.

A further object of the present invention is to provide a relative soft reduction method.

The present invention achieves the aforesaid object, and other objects that shall become clear in light of the present description, by means of a segment of a soft reduction device for carrying out a soft reduction of a slab exiting from said continuous casting machine, said segment comprising
an upper support for supporting upper rollers;
a lower support for supporting lower rollers;
adjustment units consisting of pairs of actuators arranged to adjust a relative inclination between the upper support and the lower support;
   wherein the upper support is divided into a first part, which is proximal to the slab run-in end, and a second part, which is proximal to the slab run-out end, said first part and said second part being connected to each other by at least one first hinge, allowing said first part and said second part to be movable angularly about an axis defined by said at least one first hinge;
   wherein at least one pair of first actuators, one pair of second actuators and one pair of third actuators are configured to adjust the position of said first part and said second part with respect to each other and with respect to the lower support;
   wherein the pair of first actuators, the pair of second actuators and the pair of third actuators are all arranged on said upper support or said lower support, or some are arranged on said upper support and others on said lower support;
   wherein connection elements of the pair of first actuators, which is proximal to said run-in end, are connected by a respective second hinge to a respective further connection element constrained to the lower support or to the first part of the upper support by a respective third hinge;
   wherein connection elements of the pair of second actuators, which is proximal to said at least one first hinge, are constrained, preferably directly, to the lower support, or to the first part or to the second part of the upper support, by a respective fourth hinge;
   and wherein connection elements of the pair of third actuators, which is proximal to the slab run-out end, are connected by a respective fifth hinge to a respective further connection element constrained to the lower support or to the second part of the upper support by a respective sixth hinge.

This soft reduction segment can be a soft reduction segment of a horizontal part of the continuous casting machine, or a soft reduction segment of the casting curve of said continuous casting machine, arranged completely or partially along the casting curve.

A second aspect of the invention relates to a soft reduction device of a continuous casting machine, comprising at least two soft reduction segments according to the invention.

A further aspect of the invention relates to a soft reduction method wherein, until the slab solidification cone closes, the soft reduction operation is carried out using at least one soft reduction segment, by adjusting the angle of inclination of the first part and/or the second part of the upper support with respect to the lower support.

The soft reduction segment of the invention is designed to be able to be preferably installed in the horizontal part of the continuous casting machine, where the closing of the solidification cone is provided.

In other embodiments, the soft reduction segment of the invention could be arranged completely or partially along the casting curve.

Advantageously, the hinge or hinges that hold the first part and the second part of the upper support of the segment together, in cooperation with the adjustment units, allow the geometry of the segment to be varied, ensuring independence in the inclination adjustment of the two parts of the upper support.

A further advantage is represented by the fact that the segment structure is an isostatic structure. In a preferred embodiment, ten pivoting points are provided, instead of the six pivoting points provided in the first solution of the background art (FIG. 1), in addition to the hinges which hold the first part and the second part of the upper support of the segment together.

It is possible to add a pair of actuators on the first part of the upper support for controlling at least one motorized roller inside the segment. However, it is possible to evaluate the removal of some motorized rollers when making the new segment, to the benefit of simplified plant engineering.

The solution of the invention allows the following advantages to be obtained:
a finer soft reduction profile, by halving the discretization with respect to the aforesaid first solution of the state of the art;
increased internal quality of the semi-finished product with respect to the use of said first solution;
possible use of the same number of actuators currently used in said first solution;
plant engineering simplification with respect to the aforesaid second solution of the state of the art;
lower investment and operating cost with respect to said second solution;
possibility to design the new segment with minimal changes to the rest of the machine;
the segment of the invention is suitable for small revamping.

Further features and advantages of the invention will become more apparent in the light of the detailed description of exemplary, but non-exclusive, embodiments thereof.

The dependent claims describe particular embodiments of the invention.

### BRIEF DESCRIPTION OF THE DRAWINGS

In the description of the invention reference is made to the accompanying drawings, which are provided by way of non-limiting example, in which:

FIG. 1 represents a diagram of a first solution of the state of the art relating to a soft reduction segment;

FIG. 2 schematically represents a soft reduction device with a series of segments according to the first solution of FIG. 1;

FIG. 3 represents a diagram of a first embodiment of a soft reduction segment according to the invention;

FIG. 4 schematically represents a soft reduction device with at least some segments according to the invention;

FIG. 5 schematically represents a second embodiment of a soft reduction segment according to the invention;

FIG. 6 schematically represents a top view of said second embodiment;

FIG. 7 represents three possible configurations of a soft reduction segment according to the invention;

FIG. 8 schematically represents possible variants with different positioning of the pairs of adjustment actuators on the upper support and on the lower support of a soft reduction segment according to the invention.

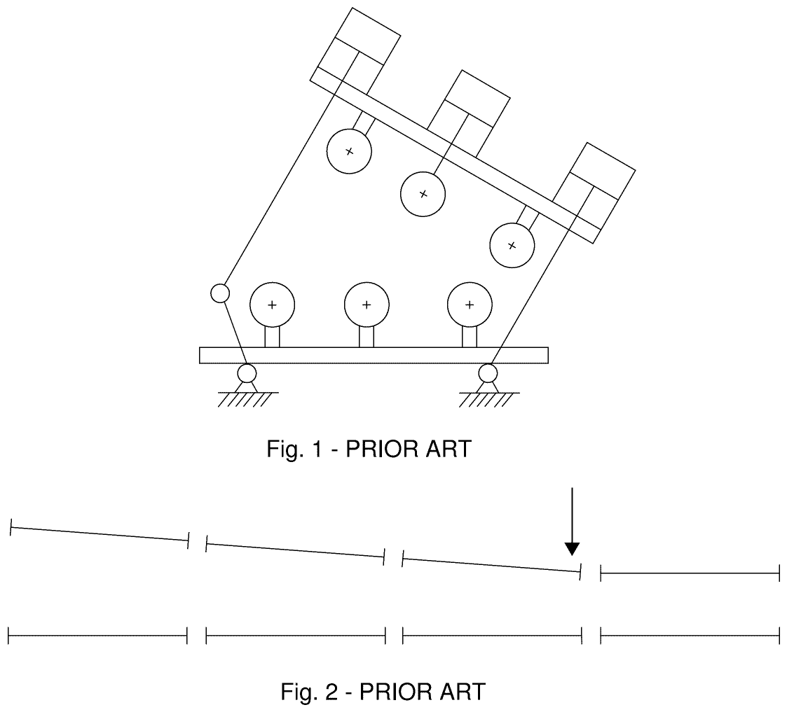

The same reference numerals and letters in the figures identify the same elements or components.

### DESCRIPTION OF EXEMPLARY EMBODIMENTS OF THE INVENTION

With reference to the Figures, examples of soft reduction segments according to the invention are illustrated, preferably but not necessarily used in a horizontal part of a continuous slab casting machine.

FIG. 4 schematically represents a soft reduction device of a continuous casting machine, comprising at least two soft reduction segments 1 according to the invention. In the non-limiting example illustrated, there are three soft reduction segments 1 according to the invention.

In all the embodiments of the invention, the soft reduction segment, preferably being part of a horizontal part of a continuous casting machine, comprises:
an upper support 2 for supporting upper rollers 2′;
a lower support 3 for supporting lower rollers 3′;
adjustment units consisting of pairs of actuators 5, 6, 7 arranged to adjust a relative inclination between the upper support 2 and the lower support 3.

Advantageously, the upper support 2 is divided into a first part 21, proximal to the slab run-in end of the segment, and a second part 22 proximal to the slab run-out end of the segment.

The first part 21 and the second part 22 are connected to each other by at least one first hinge 4, allowing said first part 21 and said second part 22 to be movable angularly about an axis defined by said at least one first hinge 4. Preferably two hinges 4 are provided defining the same axis.

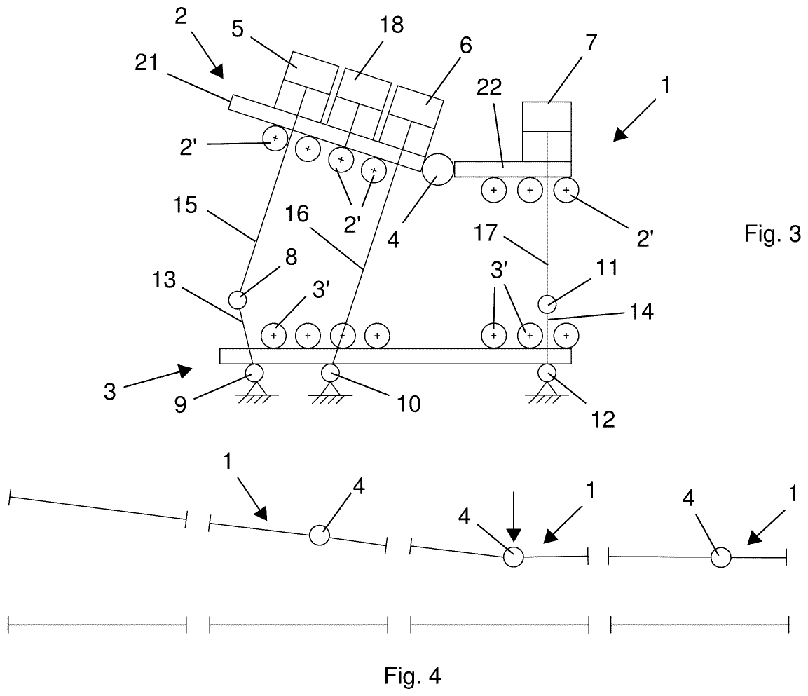

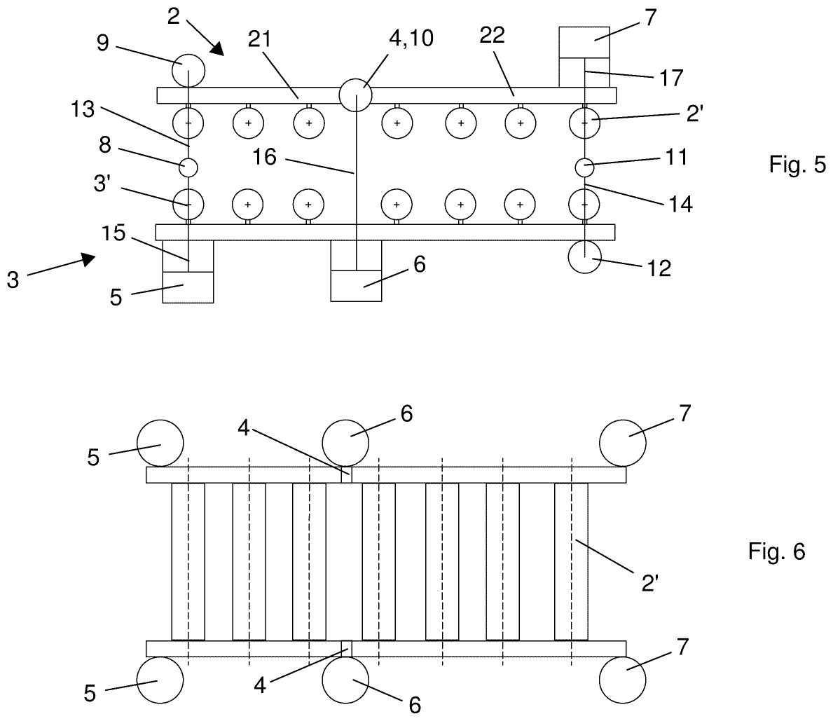

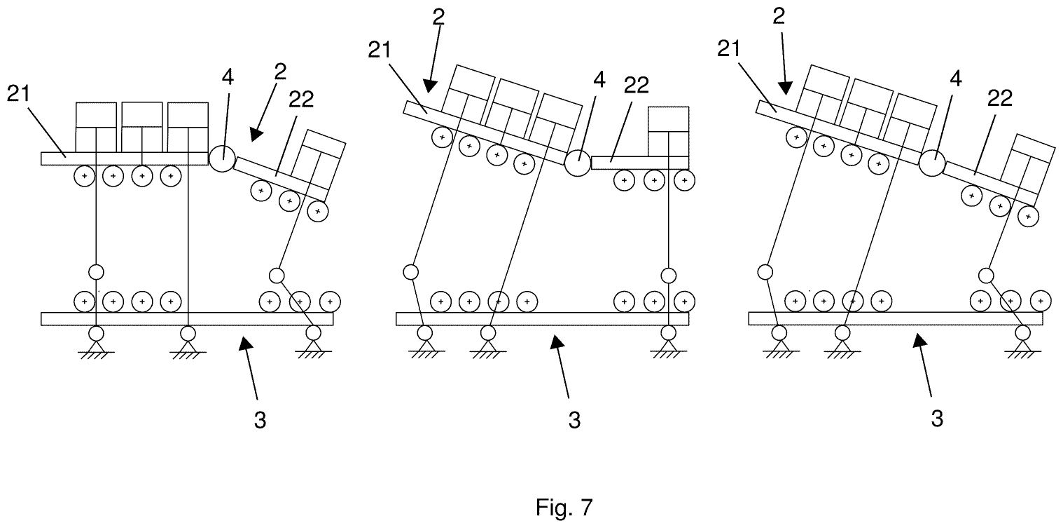

In the non-limiting examples of FIGS. 3 and 5, seven upper rollers 2′ and corresponding seven lower rollers 3′ are provided in each soft reduction segment.

For example, in the first part 21 of the upper support 3 three or four upper rollers 2′ are provided, while in the second part 22 four or three upper rollers 2′ are provided, respectively.

Advantageously, at least one pair of first actuators 5, one pair of second actuators 6 and one pair of third actuators 7 are provided, these pairs of actuators being configured to adjust the position of the first part 21 and of the second part 22 with respect to each other and with respect to the lower support 3.

The pair of first actuators 5, the pair of second actuators 6 and the pair of third actuators 7 are all arranged on the upper support 2 or on the lower support 3, or some are arranged on said upper support 2 and others on said lower support 3.

The actuators are, preferably but not necessarily, hydraulic actuators, e.g., in the form of cylinders.

Advantageously, connection elements 15, e.g., piston rods, of the pair of first actuators 5, which is proximal to said slab run-in end, are connected by a respective second hinge 8 to a respective further connection element 13, e.g., a respective further rod, constrained to the lower support 3 (e.g. in FIG. 3) or to the first part 21 of the upper support 2 (e.g. in FIG. 5) by a respective third hinge 9.

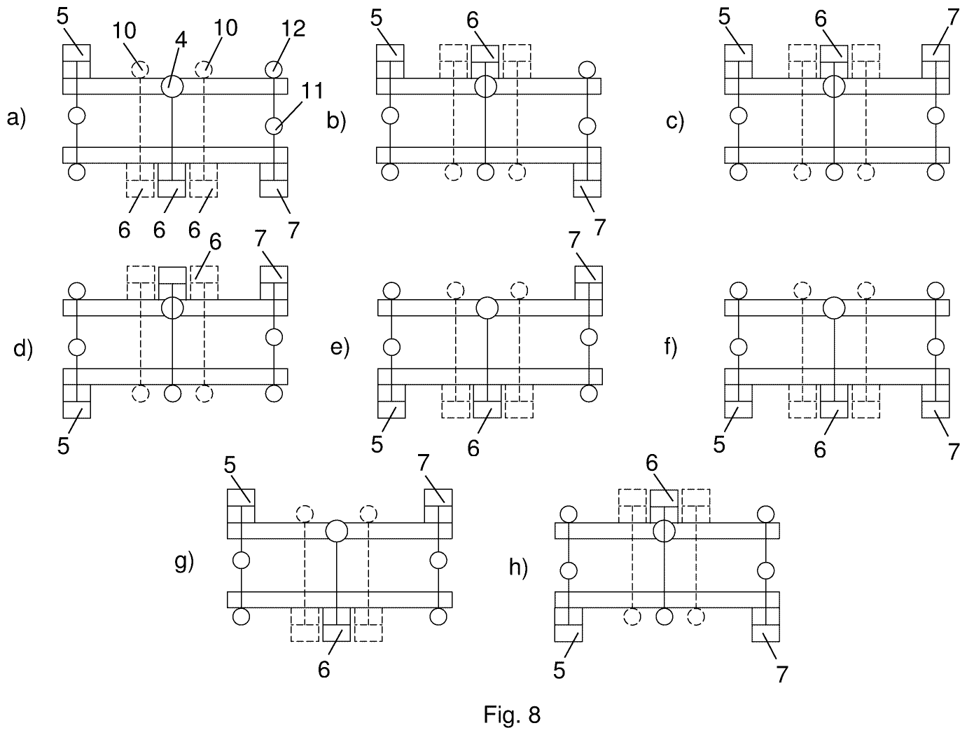

Connection elements 16, e.g., piston rods, of the pair of second actuators 6, which is proximal to the at least one first hinge 4, are constrained, preferably directly, to the lower support 3 (e.g. in FIG. 3), or to the first part 21 or to the second part 22 of the upper support 2 (e.g. in diagrams a), e-g) of FIG. 8), by a respective fourth hinge 10.

Finally, connection elements 17, e.g., piston rods, of the pair of third actuators 7, which is proximal to said slab run-out end, are connected by a respective fifth hinge 11 to a respective further connection element 14, e.g., a respective further rod, constrained to the lower support 3 (e.g., in FIG. 3) or to the second part 22 of the upper support 2 (e.g., in diagram b) of FIG. 8) by a respective sixth hinge 12.

Preferably, but not necessarily, if the pair of second actuators 6 is arranged on the lower support 3, the two fourth hinges 10 can coincide with the two first hinges 4, and preferably each second actuator 6 has an axis perpendicular to the axis of the respective first hinge 4 (see for example FIG. 5).

In all the variants, the axis defined by the at least one first hinge 4 is fixed or movable.

Preferably, the lower support 3 is fixed, preferably made as a single piece.

In a first variant of the invention, both the pair of first actuators 5 and the pair of second actuators 6 are arranged on the first part 21 of the upper support 2 or on a first portion of the lower support 3 corresponding to said first part 21; and the connection elements, or piston rods, 15, 16 of each first actuator 5 and second actuator 6 are connected to the first portion of the lower support 3 or to the first part 21 of the upper support 2 so as to adjust the angle of inclination of the first part 21 of the upper support 2 with respect to the lower support 3.

In this case, the pair of third actuators 7 is arranged on the second part 22 of the upper support 2 or on a second portion of the lower support 3 corresponding to said second part 22; and the connection elements 17, e.g. the piston rods, of each third actuator 7 are connected to the second portion of the lower support 3 or to the second part 22 of the upper support 2 so as to adjust the angle of inclination of the second part 22 of the upper support 2 with respect to the lower support 3.

In a second variant of the invention, both the pair of second actuators 6 and the pair of third actuators 7 are arranged on the second part 22 of the upper support 2 or on a second portion of the lower support 3 corresponding to said second part 22; and the connection elements, or piston rods, 16, 17 of each second actuator 6 and third actuator 7 are connected to the second portion of the lower support 3 or to the second part 22 of the upper support 2 so as to adjust the angle of inclination of the second part 22 of the upper support 2 with respect to the lower support 3.

In this case, the pair of first actuators 5 is arranged on the first part 21 of the upper support 2 or on a first portion of the lower support 3 corresponding to said first part 21; and the connection elements, or piston rods, 15 of each first actuator 5 are connected to the first portion of the lower support 3 or to the first part 21 of the upper support 2 so as to adjust the angle of inclination of the first part 21 of the upper support 2 with respect to the lower support 3.

In a third variant of the invention, the pair of first actuators 5 is arranged on the first part 21 of the upper support 2, while the pair of second actuators 6 is arranged on a first portion of the lower support 3 corresponding to said first part 21, or vice versa; and the connection elements, or piston rods, 15 of each first actuator 5 are connected to the first portion of the lower support 3 while the connection elements, or piston rods, 16 of each second actuator 6 are connected to the first part 21 of the upper support 2, or vice versa, so as to adjust the angle of inclination of the first part 21 of the upper support 2 with respect to the lower support 3.

In this case, the pair of third actuators 7 is arranged on the second part 22 of the upper support 2 or on a second portion of the lower support 3 corresponding to said second part 22; and the connection elements, or piston rods 17, of each third actuator 7 are connected to the second portion of the lower support 3 or to the second part 22 of the upper support 2 so as to adjust the angle of inclination of the second part 22 of the upper support 2 with respect to the lower support 3.

In a fourth variant of the invention, the pair of third actuators 7 is arranged on the second part 22 of the upper support 2, while the pair of second actuators 6 is arranged on a second portion of the lower support 3 corresponding to said second part 22, or vice versa; and the connection elements, or piston rods, 17 of each third actuator 7 are connected to the second portion of the lower support 3 while the connection elements, or piston rods, 16, of each second actuator 6 are connected to the second part 22 of the upper support 2, or vice versa, so as to adjust the angle of inclination of the second part 22 of the upper support 2 with respect to the lower support 3.

In this case, the pair of first actuators 5 is arranged on the first part 21 of the upper support 2 or on a first portion of the lower support 3 corresponding to said first part 21; and the connection elements, or piston rods, 15 of each first actuator 5 are connected to the first portion of the lower support 3 or to the first part 21 of the upper support 2 so as to adjust the angle of inclination of the first part 21 of the upper support 2 with respect to the lower support 3.

All the possible combinations of the positions of the pair of first actuators 5, of the pair of second actuators 6 and of the pair of third actuators 7 are illustrated in the diagrams of FIG. 8. With reference to the second actuators 6, in each diagram from a) to h) the two positions indicated with a broken line represent the two alternative positions with respect to the position indicated with a continuous line.

In all the variants of the soft reduction segment of the invention there can be a pair of fourth actuators 18 between the pair of first actuators 5 and the pair of second actuators 6 to control a motorized upper roller inside the segment.

Advantageously, in the soft reduction method carried out by means of a soft reduction device according to the invention, until the slab solidification cone closes, the soft reduction operation is carried out using at least one soft reduction segment 1, by adjusting the angle of inclination of the first part 21 and/or the second part 22 of the upper support 2 with respect to the lower support 3. Preferably, the closing of the slab solidification cone is carried out at the at least one first hinge 4 of a soft reduction segment 1.

There being provided at least the pair of first actuators 5, the pair of second actuators 6 and the pair of third actuators 7 to adjust the position of the first part 21 and the second part 22 with respect to each other and with respect to the lower support 3, and these pairs of actuators 5, 6, 7 all being arranged on the upper support 2 or on the lower support 3, or some being arranged on the upper support 2 and others on the lower support 3, the soft reduction operation is carried out by means of the upper rollers 2′ of the upper support 2 and lower rollers 3′ of the lower support 3 during an angular upward and/or downward movement of the first part 21 and/or second part 22 of the upper support 2 about the axis defined by the first hinge or first hinges 4, by means of the combined actuation of the pair of first actuators 5, the pair of second actuators 6, and the pair of third actuators 7.

1. A soft reduction segment of a continuous casting machine, said segment being suitable for carrying out a soft reduction of a slab exiting from said continuous casting machine, the segment comprising
an upper support for supporting upper rollers;
a lower support for supporting lower rollers;
adjustment units consisting of pairs of actuators arranged to adjust a relative inclination between the upper support and the lower support;
wherein the upper support is divided into a first part, which is proximal to the a slab run-in end of the segment, and a second part, which is proximal to the a slab run-out end of the segment, said first part and said second part being connected to each other by at least one first hinge, allowing said first part and said second part to be movable angularly about an axis defined by said at least one first hinge;
wherein at least one pair of first actuators, one pair of second actuators and one pair of third actuators are configured to adjust the a position of said first part and said second part with respect to each other and with respect to the lower support;
wherein the pair of first actuators, the pair of second actuators and the pair of third actuators are all arranged on said upper support or said lower support, or some are arranged on said upper support and others on said lower support;
wherein connection elements of the pair of first actuators, which is proximal to said run-in end, are connected by a respective second hinge to a respective further connection element constrained to the lower support or to the first part of the upper support by a respective third hinge,
wherein connection elements of the pair of second actuators, which is proximal to said at least one first hinge, are constrained, preferably directly, to the lower support, or to the first part or to the second part of the upper support, by a respective fourth hinge, and wherein connection elements of the pair of third actuators, which is proximal to the slab run-out end, are connected by a respective fifth hinge to a respective further connection element constrained to the lower support or to the second part of the upper support by a respective sixth hinge.

2. The soft reduction segment according to claim 1, wherein, if the pair of second actuators is arranged on said lower support, the two fourth hinges can coincide with two first hinges, and preferably each second actuator has an axis perpendicular to the axis of the respective first hinge.

3. The soft reduction segment according to claim 1, wherein the axis defined by said at least one first hinge is fixed or movable.

4. The reduction segment according to claim 1, wherein the lower support is fixed, preferably made in a single piece.

5. The reduction segment according to claim 1, wherein the actuators are hydraulic actuators.

6. A soft reduction device of a continuous casting machine, the device comprising at least one soft reduction segment according to claim 1, adapted to be arranged in a horizontal part of the continuous casting machine, or adapted to be arranged either completely or partially along a casting curve.

7. A soft reduction method carried out by means of a device according to claim 6, wherein, until a slab solidification cone closes, a soft reduction operation is carried out using at least one soft reduction segment, by adjusting an angle of inclination of the first part and/or second part of the upper support with respect to the lower support.

8. The method according to claim 7, wherein a closing of the slab solidification cone is carried out at said at least one first hinge of the at least one soft reduction segment.

9. The method according to claim 7, wherein said soft reduction operation is carried out by means of the upper rollers and the lower rollers during an angular movement upwards and/or downwards of the first part and/or of the second part of the upper support about the axis defined by said at least one first hinge, by means of a combined actuation of the pair of first actuators, the pair of second actuators and the pair of third actuators.
